(19) United States
(12) Patent Application Publication
(10) Pub. No.: US 2023/0236711 A1
(43) Pub. Date: Jul. 27, 2023

(54) AUTOMATIC EBOOK PAGE TURNING SYSTEM

(71) Applicant: Alex Edson, Scottsdale, AZ (US)

(72) Inventor: Alex Edson, Scottsdale, AZ (US)

(21) Appl. No.: 17/584,086

(22) Filed: Jan. 25, 2022

(51) Int. Cl. G06F 3/0483; G06F 3/04847

(52) U.S. Cl. CPC G06F 3/0483; G06F 3/04847; G06F 2203/04806

(57) ABSTRACT

Systems and methods for automatically turning pages of an eReader.

### TECHNICAL FIELD

Embodiments of the invention relate to systems and methods for automatic page turning for eBooks.

### BACKGROUND

As the world has transitioned further into the digital realm and away from the physical or analog realm, the way people read and learn new information has evolved. While in the past most people read and absorbed information in physical form from books, magazines, and newspapers, the modern ubiquity of computing devices has given rise to an increase in digitally available information. Older media such as physical books have given way to data files that are stored in computer memory which is now displayed on a device screen when the file is accessed by a user in the form of an eBook. These files are often purchased and downloaded on devices via the internet.

A wide variety of devices are capable of displaying these eBooks and other information files. Some devices are dedicated specifically to the task of reading, such as eReaders (e.g. Amazon's Kindle™) and may not perform computing functions other than eBook downloading and display, as well as basic movement (e.g., forward, back, and others), and highlighting functions relating to review of the downloaded information. Other devices, such as tablets, smartphones, laptop computers, desktop computers, and others can offer additional functions, such as multiple viewing and display settings. Still, other devices may not be frequently used to display material of this sort at this point in time, but are expected to become more relevant in the space as their technological capabilities increase and they receive more widespread adoption. Wearable technologies, such as glasses with displays and watches, projector and hologram devices, virtual and augmented reality headsets and glasses, video game consoles, and other emerging technology can all be expected to become more prevalent in the eBook and other digital publication display space in the near future. While all of these devices may, in certain circumstances, provide convenience, economic, and physical advantages over physical media such as books, they all suffer a critical flaw: they still require manual input from their readers during use.

As an example of these manual-input limitations, current eBook Readers require their users to physically click, press a button, swipe, or take some other action, in order to interact with their device to turn to the next page and advance the text available to the user. For those who read for long periods of time, this repetitive clicking and swiping can be inconvenient, uncomfortable, and even physically demanding. This is especially true for those with physical disabilities or injuries and have problems with repetitive motions or lack the ability to physically interact with the device.

Thus, it would be beneficial for an eReader, or other device, to provide a system that gives the user the ability to review eBooks, magazines, newspapers, articles, or other similar digital reading information and use methods to automatically turn a page or otherwise navigate the information in a digital publication, particularly if the system can determine a user's reading speed and tailor its page-turning mechanism to the needs, habits, or reading patterns of the individual user.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The systems and methods described herein provide automatic page turning in eBooks, magazines, newspapers, articles, or other similar digital reading information.

The systems and methods described herein include adjustable reading speed settings that enable readers to modify automatic page turning speed.

In various example embodiments the technology analyzes how many words are on a particular page, how many characters are in those words, and then, based on the user's reading speed (e.g. 250 words per minute) as determined, for example, by a standardized reading pilot test, a user's manual self report of their reading speed, recognition of a user's reading speed while they are using the system and modification of the speed at which the pages turn based on that analysis, or a combination of one or more of the above analytic tools, turns the page for the user without any other user input (physical or oral). As such, the user does not need to click or select a “next” button to go to the next page.

In some embodiments, the system can automatically analyze the user's reading speed and adjust the speed a which it turns pages accordingly. In some embodiments, users can manually set and/or modify their reading speed.

In some embodiments, users can override the speed at which page turning occurs and/or adjust it according to their preference or preset reading speeds programmed into the system.

Websites, mobile, smartphone, tablet, and desktop implementation of these methods and systems are contemplated, as is dedicated digital reader device implementation.

In one aspect, the systems can calculate the number of words, characters, and/or syllables on a page to determine an appropriate, and/or approximate, amount of time a user requires for reading a particular page. In some optional embodiments, the systems can also evaluate the complexity and difficulty of the words, sentence structure, and/or language type and adjust the reading speed up or down as appropriate to compensate for changes in complexity and difficulty of the information.

The systems can also detect if digital information being read by a user has been hidden, minimized, or if the user is not focused on the device (using the device camera and facial recognition features, provided access to these utilities and functions are enabled) and can automatically pause an active page turning operation until the relevant indicators demonstrate that the user has resumed their reading activities.

The systems can optionally include a timer that displays a related visual component that counts down a predetermined and/or preset amount of time the user is allotted to read a page before the system automatically turns to the next page.

The systems can automatically re-calculate the number of words, characters, and syllables present on a particular page and adjust the page turning speed if the user initiates an action that causes a change to the content and/or quantity on a particular page. By way of example, if the user modifies (a) the size of a eBook reader window (e.g. by entering “fullscreen mode”), (b) increases/decreases the size of the text and thus the amount of text available on a viewed page, and/or (c) modifies the font and/or typeface, etc., the systems can instantly rescan the page and adjust the timing of the page turning activity accordingly.

In one optional aspect of the systems, there is a slider or other user-adjustable reading speed modification mechanism that a user can interact with by using their voice or cursor to modify the reading and page turning parameters.

In one aspect, the systems can automatically pause the countdown timer if the user is interacting with the device. For example, if the user moves their cursor outside of the reading application, taps their screen, highlights a passage of text, or inserts a margin note, the countdown timer can automatically pause to accommodate such interactions.

In one aspect, the systems can automatically resume (i.e. “unpause”) the countdown timer when inactivity is detected for more than five (5) seconds following a user-initiated action (e.g., cursor movement, mouse click, text highlight, margin note, etc.).

In one aspect, the systems can suggest a reading speed to the user by conducting a brief reading speed test/assessment.

In some embodiments, the systems can automatically analyze the user's reading speed and adjust the speed at which it turns pages accordingly.

In some embodiments, users can override the speed at which page turning occurs and/or adjust it according to their preference.

In one aspect, the systems can locally store (i.e. “remember”) the user's reading speed preferences. Optionally, such preferences can be stored in association with a user's profile on the device or within the systems of the present invention.

The systems and methods of the present invention can be used on interactive websites, smartphone apps, and tablet-based software (e.g. iOS™ and Android™ applications), desktop and laptop software for computers running MacOS™, Windows™, Linux™ (or any other operating system), and dedicated eReader devices (e.g. Amazon's Kindle™).

Other objects and advantages of the various embodiments of the present invention will become obvious and intuitive to the reader and it is intended that these objects and advantages are within the scope of the present invention. To the accomplishment of the above and related objects, this invention can be embodied in the form illustrated in the accompanying drawings, attention being called to the fact, however, that the drawings are illustrative only, and that changes can be made in the specific construction illustrated and described within the scope of this application.

### BRIEF DESCRIPTION OF THE DRAWINGS

A more complete understanding of the embodiments, and the attendant advantages and features thereof, will be more readily understood by references to the detailed description herein when considered in conjunction with the accompanying drawings and the understanding, skill, and experiences of one of skill in the relevant art, wherein:

FIG. 1 illustrates a device architecture diagram, according to some embodiments;

FIG. 2 illustrates an operation flowchart, according to some embodiments;

FIG. 3 illustrates a visual representation of a page of digital information presented according to the present systems on an eReader device, according to some embodiments;

FIG. 4 illustrates a word counting operation of an eReader device, according to some embodiments;

FIG. 5 illustrates a letter counting operation of an eReader device, according to some embodiments;

FIG. 6 illustrates text/font resizing operation of an eReader device, according to some embodiments;

FIG. 7 illustrates reading speed settings modification of an eReader device, according to some embodiments;

FIG. 8 illustrates an eReader on a laptop computer, according to some embodiments;

FIG. 9 illustrates a word counting operation of an eReader on a laptop computer, according to some embodiments;

FIG. 10 illustrates font resizing operation of an eReader on a laptop computer, according to some embodiments; and

FIG. 11 illustrates a letter counting operation of an eReader on a laptop computer, according to some embodiments;

FIG. 12 illustrates reading speed settings modification of an eReader on a laptop computer, according to some embodiments.

### DETAILED DESCRIPTION

The systems and methods disclosed and described herein incorporate a number of embodiments. Any specific details of the embodiments described herein are used for demonstration purposes only, and not intended to define limitation(s) or limit inference(s) regarding the invention.

Before describing in detail exemplary embodiments, it is noted that the embodiments of the present invention reside primarily in combinations of the described components of the systems and methods as implemented in particular devices that can be used to practice the present invention. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In some embodiments, the systems and methods herein analyze one or more variables in order to accurately assess and set the speed at which page turns can occur. A first variable that is analyzed can include a method for counting the number of words on a page that are, or can be displayed to the reader. A second variable that can be analyzed is the number of characters in the displayed words that are, or can be displayed to the reader. A third variable that can be analyzed is the user's average, mean, current session, pilot tested, or manually-input reading speed.

Counting the number of words, characters, and/or syllables that are displayed can be completely or relatively objective measurements. The systems and methods can use one or more methods of determination, including checking for spaces between characters and/or words. In some instances, particular fonts and typefaces that a user can select or that are provided by eReader programs, device interfaces, and text control could interfere with automating such determinations, in which case other methods of determining word count, character count, and syllable count can be utilized.

In some embodiments, the systems and methods convert numerical values to text values as part of their determination operation. By way of example, if the number “77” appears in evaluated text, that number is classified not as two characters but rather as thirteen characters (the human brain reads “77” as “seventy-seven” (13 characters, 5 syllables). Turning now to the third variable, analysis of a user's reading speed can be a more dynamic and non-static determination than measuring the first two variables, and can change according to a variety of different factors. For example, a user may not be paying full attention to the reading material and this could change the rate at which they are reading the words on any particular page. The reader/user could be distracted or have their reading speed impacted by any one or more of a number of conditions, such as watching young children nearby, feeling drowsy at night or near a nap time, moving and/or thinking slowly due to medication, or otherwise being subject to frequent interruptions such as calls or visitors, or any of a number of other factors. The systems and methods disclosed herein are able to monitor and measure the user's attention and change the page turning speed accordingly in many instances. In some embodiments, this can be accomplished by using one or more cameras built into or connected to or otherwise coupled with the reading device to monitor the user's eyes and determine if the user is watching the screen. In some embodiments, determining if the device is moving using one or more accelerometers and/or gyroscopes can be used to determine if the device is being picked up or set down, moved around, and/or otherwise placed in less than optimal reading conditions.

It should be understood that some embodiments can employ Artificial Intelligence (AI) and/or Machine Learning (ML) (collectively referred to herein as AI/ML, which can be inclusive of both AI and ML and exclusive of one or the other in various embodiments) to determine a user's reading speed. This can involve a number of different calculations and a wide variety of variables. These AI/ML determinations can be based on population-based training, supplemented by information unique to the individual user, include environmental factors, the systems learning reading habits from different users and applying them in specific situations, or a hybrid model of any number of conditions. As an example, the systems could learn that a particular user changes their reading speed in the morning with a cup of coffee. The user can start out at a slower speed and as the caffeine from the coffee impacts their systems, their reading speed can increase slightly or dramatically. They may also enjoy reading on their lunch break and generally have a different lunchtime reading speed. Finally, they may enjoy reading in bed before falling asleep, and may slowly decrease their reading speed as they relax and their body prepares for sleep. The systems and methods herein can automatically adjust for these changing conditions in some embodiments. For example, if the user is practicing speed-reading and desires to gradually increase the difficulty level (the speed at which pages turn), the systems can learn the user's reading habits or receive feedback from the user as to their desired reading goals and adjust the weights and biases of the machine learning model accordingly.

Alternatively or additionally, environmental factors can be monitored and used with one or more models to automatically adjust a user's reading speed based on AI/ML. This could include determining an amount of ambient light in a particular location when a user is reading. Low light or very bright light environments could create more eye strain and fatigue for a reader that could impact the speed at which they are reading and may slow them down, eventually. Similarly, ambient noise in a particular environment can impact a user's comprehension and thus the speed at which they are reading a particular type of material. For example, if the technology detects that the user is reading in a quiet room (e.g. a library), then the systems' page turning speed can automatically increase at an accelerated rate. Alternatively, if the user is reading in a noisy construction site or a busy office cubicle, then the systems can automatically decrease its page turning speed. Such environmental settings/preferences can be enabled or disabled by the user, such as through their privacy settings or other preferences that impact the systems' ability to draw information from or otherwise interact with the device's hardware (e.g. camera, acceleromator, and/or others) and other features and functions (e.g. brightness settings, facial recognition, and/or others).

AI/ML can also be used on a larger scale to monitor and learn from other test data sets and other system users and apply the lessons to individual users. In some embodiments, the systems and methods herein can account for each user's age, or other information they input manually, or otherwise make available to the systems (such as linking it with other user accounts that hold certain user data) and apply the typical speed for similar users. Eyesight ability could similarly be applied and scored. Some languages, text types and fonts can be particularly dense and may take users longer to read (e.g. content related to mathematics, legal literature, etc.), which could be learned and applied as a data input for the systems and methods.

In various embodiments, a pre-programmed (i.e. “default”) reading speed for a user can be determined and applied by the systems and methods herein. For instance, the systems' default reading speed can be 250 words per minute (the average reading speed for most adults).

In various embodiments, the systems and methods can automatically detect the language of the text on the page and adjust the reading speed accordingly. For example, if the material displayed on the page is in Arabic, the default reading speed can be adjusted to 138 words per minute (Arabic words are typically longer than English words, thus supporting a different speed determination).

In various embodiments, the user can submit “1-click feedback” within the eReader window if the user feels that a particular page is turning too quickly or slowly. This data can be used to train the systems' neural network (thus fine-tuning the reading-speed formulas for other users). For example, upon hovering the user's cursor in a particular location, a thumbs-up/thumbs-down button can be present, enabling the user to effortlessly “vote” and report issues with page-turning speed.

In some instances, the systems and methods herein can recognize the type of material being read. While literature with technical or legal information can take longer to read, literature that is fictional in nature or written in a more simplistic manner (e.g., digital news or digital celebrity or fashion short articles, or other articles) can be easier and faster to read.

Once the variables concerning the number of words, characters, and/or syllables, on a page are recognized, the systems and methods herein provide that one or more mathematical formulas can be used to calculate an estimated length of time for a user/reader to read all of the words on a page. For example, if there are 250 words on a particular page and each of the 250 words has an average of 4.7 characters (the average number of characters in an English word), and the user's reading speed is 250 words per minute (also referred to “WPM”), the systems can automatically turn to the subsequent page after approximately, or exactly, 60 seconds has elapsed.

The example embodiments herein can also be adaptive to user input in real-time. The systems and methods herein apply mathematical formula(s) to automatically adapt to user-input affecting how many words are displayed on-screen at a particular time. For example, if the user adjusts the eReader window to decrease or increase its size (i.e. enters “full-screen mode”), makes the text appear smaller or larger on the screen (i.e. “zooms-in” or “zooms-out”), or performs any action that affects how many words are displayed on the screen, the systems and methods can instantly update its calculations in real-time (and with it, the countdown timer). If the user “zooms-in,” this can cause text appearing on a display of the eReader to become larger, therefore causing a reduction in the amount of time remaining on the countdown timer because there are now fewer words to read on the page. The opposite can also be true: if the user “zooms-out,” this can increase the number of words on the page, therefore increasing the amount of time allotted on the countdown timer.

The systems and methods herein can also employ a “smart pause.” If the user moves their mouse cursor or taps their device's screen to highlight a passage of text or post a comment (e.g., to leave a note in an eBook page's margins), the systems and methods herein can “pause” the systems' one or more timers. Once the user is finished highlighting and/or note-taking, the timer can automatically resume. This smart pause feature can cause the systems to “wait” until inactivity has been detected for a pre-determined period of time (e.g. 5 seconds) before resuming. Thus, user input actions such as moving a mouse cursor, clicking a button, or touching the screen (with appropriate functionality of the device), or leaving a note can pause the one or more timers. Thereafter, the timer(s) can automatically unpause after the pre-determined amount of time has elapsed (i.e. when the user is done note-taking or highlighting, signified by a few seconds of inactivity).

To elaborate on the topic of timers, the systems and methods herein can include one or more timers that count down or count up and once a time condition is reached (e.g. the timer counts down to zero or counts up to the appropriate, preset time), then the page can turn. These timers are dynamic and adaptable in many embodiments, enabling the systems to change and modify operation based on operating conditions, user attention, and other factors.

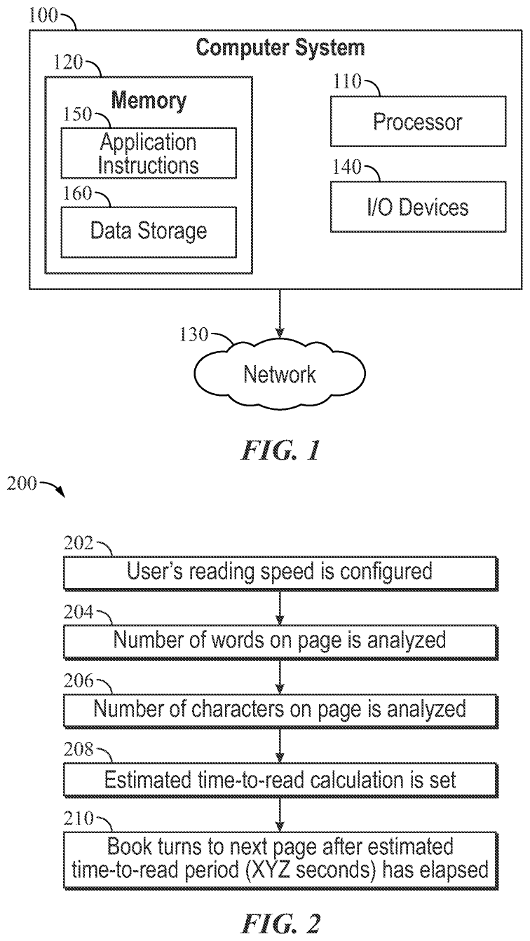

FIG. 1 illustrates a device architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, an eBook reader or dedicated eReader device, or the like. The computer system 102 includes one or more processors 110 coupled to a memory 120 via an input/output (I/O) interface. Computer system 102 can further include a network interface to communicate with the network 130. One or more input/output (I/O) devices 140, such as video device(s) (e.g. a camera), audio device(s), and display(s) are in operable communication with the computer system 102. In some embodiments, similar I/O devices 140 can be separate from computer system 102 and can interact with one or more nodes of the computer system 102 through a wired or wireless connection, such as over a network interface. In many embodiments, computer system 102 can be a server that is fully automated or partially automated and can operate with minimal or no interaction or human input during processes described herein. As such, many embodiments of the processes described herein can be fully automated or partially automated. In instances where a server is provided, connections through a network 130 can allow the server to store information in one or more databases that can be used for the adaptive learning, artificial intelligence operations, machine learning, or other functions supporting the systems and methods of the present invention.

Processors 110 suitable for the execution of a computer program include both general and special purpose microprocessors and any one or more processors of any digital computing device. The processor 110 can receive instructions and data from a read-only memory or a random-access memory or both. The essential elements of a computing device are a processor for performing actions in accordance with instructions and one or more memory devices for storing instructions and data. Generally, a computing device can also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface can be configured to allow data to be exchanged between the computer system 102 and other devices attached to a network 130, such as other computer systems, or between nodes of the computer system 102. In various embodiments, the network interface can support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 can include application instructions 150, configured to implement certain embodiments described herein, and at least one database or data storage 160, comprising various data accessible by the application instructions 150. In at least one embodiment, the application instructions 150 can include software elements corresponding to one or more of the various embodiments described herein. For example, application instructions 150 can be implemented in various embodiments using any desired programming language, scripting language, or combination of programming languages and/or scripting languages (e.g., C, C++, C#, JAVA®, JAVASCRIPT®, PERL®, PHP, Python, TensorFlow, Ruby on Rails, React, etc.).

The steps and actions of the computer system 102 described in connection with the embodiments disclosed herein can be embodied directly in hardware, in a software module executed by a processor, or in a combination of the two. A software module can reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium can be coupled to the processor 110 such that the processor 110 can read information from, and write information to, the storage medium. In the alternative, the storage medium can be integrated into the processor 110. Further, in some embodiments, the processor 110 and the storage medium can reside in an Application Specific Integrated Circuit (ASIC). In the alternative, the processor and the storage medium can reside as discrete components in a computing device. Additionally, in some embodiments, the events or actions of a method or algorithm can reside as one or any combination or set of codes and instructions on a machine-readable medium or computer-readable medium, which can be incorporated into a computer program product.

Also, any connection can be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, or others can be included in the definition of medium. “Disk” and “disc,” as used herein, include compact disc (CD), laser disc, optical disc, digital versatile disc (DVD), and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) accessible and/or based, and a network server can include a web server delivering HTML, XML, etc., web pages to the computing devices. In some embodiments, a client-server architecture can be implemented, in which a network server executes enterprise and custom software, exchanging data with custom client applications running on the computing device 102.

FIG. 2 illustrates an operation flowchart 200 according to an example embodiment. As shown in the example embodiment, a first step 202 can include configuration of a user's reading speed. A second step 204 can include the system analyzing the number of words on a page, or on multiple pages, or all pages within the target digital information collection. A third step 206 can include the system analyzing the number of characters on a page, or on multiple pages, or all pages. A fourth step 208 can include the system performing an estimated time-to-read calculation or otherwise setting such calculation up to be performed. A fifth step 210 can include the system executing a page turning operation for the book based on an estimated time-to-read period (e.g., xyz seconds, where xyz is a number) has elapsed.

In some embodiments, optical character recognition (OCR) can be used to determine or analyze the number of words and characters within images on a particular page. This can help to improve the accuracy of the page turning speed formula, particularly if the underlying text originated from a scanned book copy and lacks native digital text within the ebook or other digital textual information to be analyzed.

It should be understood that while this document describes implementation of the system and methods of the present invention in eBooks primarily, the same or similar systems and methods can be adapted for other types of digital reading material, such as journals, pamphlets, brochures, diaries, newspapers, magazines, blogs, or many others. By way of example, Apple Books™ (eReader software installed by default on MacBooks™) allows users to upload PDFs into their eBook library. In such instances, there may or may not be analogous structures to a book's pages (i.e. the display may be scrollable and not have predefined “pages”) but the systems and methods herein allow for moving or navigating through the material in a similar page turning fashion. User interface elements could cause for quick scrolling from one displayed section to the next, an eBook page turning animation or feature, or other forwarding mechanisms and interfaces, as appropriate.

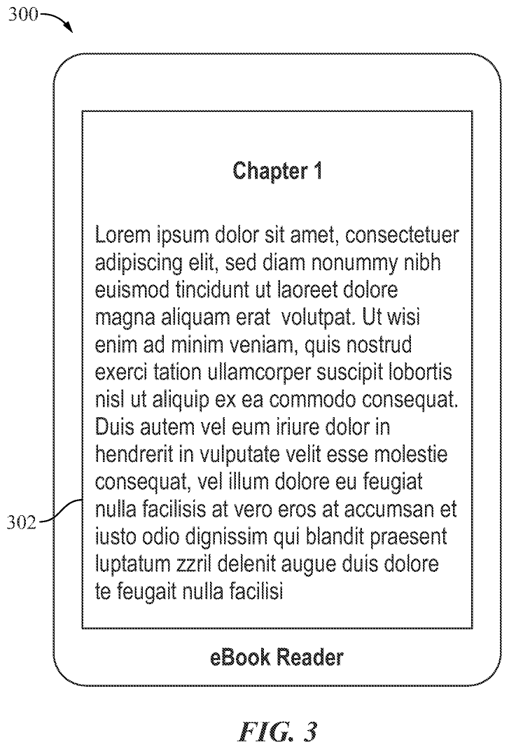

FIG. 3 illustrates an eBook reader or eReader device 300, according to some embodiments. As shown in the example embodiment, these devices can include a display 302 that shows one or more pages with text, characters, images, or other information.

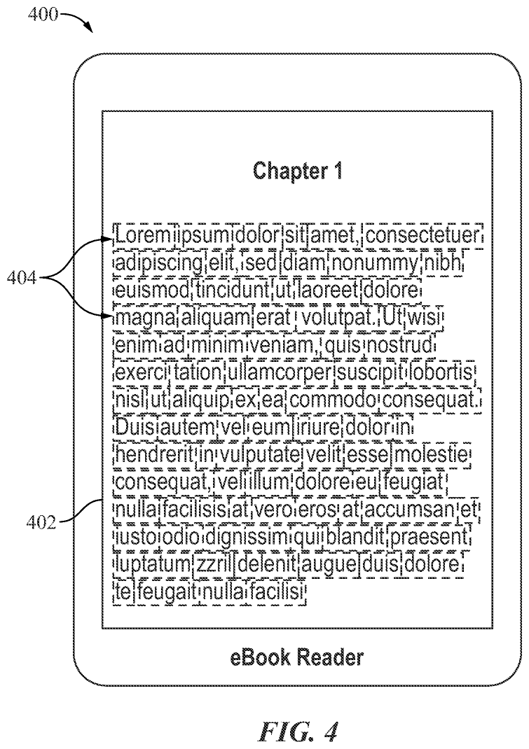

FIG. 4 illustrates a word counting operation of an eReader device 400, according to some embodiments. As shown in the example embodiment, the systems and methods described herein are able to determine individual words 404 on display 402 of the device, including where they begin and end, punctuation, and/or spaces in between them in various embodiments and use such information in calculations to determine appropriate page turning speeds.

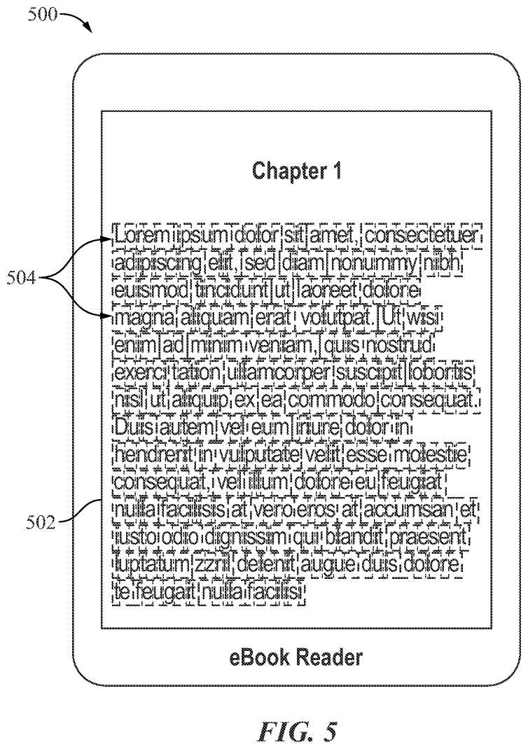

FIG. 5 illustrates a letter counting operation of an eReader device 500, according to some embodiments. As shown in the example embodiment, the systems and methods described herein can differentiate distinct letters, numbers, punctuation, and other characters 504, and determine a quantity of letters, numbers, punctuation, and/or other characters displayed on a screen 502 in its operations to determine appropriate speeds for page turning.

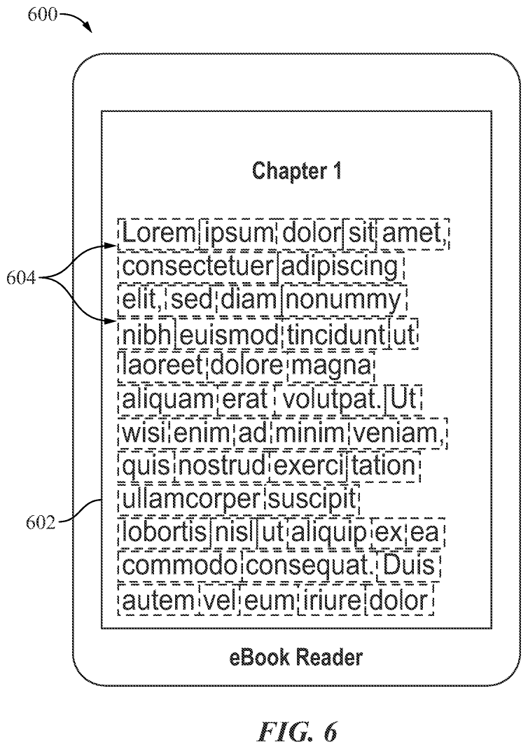

FIG. 6 illustrates font resizing operation of an eReader device 600, according to some embodiments. As shown in the example embodiment, words 604 that are displayed on screen 602 of the device can be increased or decreased in size based on different zooming or display options available to the user. The system is operable to determine adjustments in automated page turning operations based on these resizing operations by re-calculating the number of words (and/or characters) that are displayed on a particular screen.

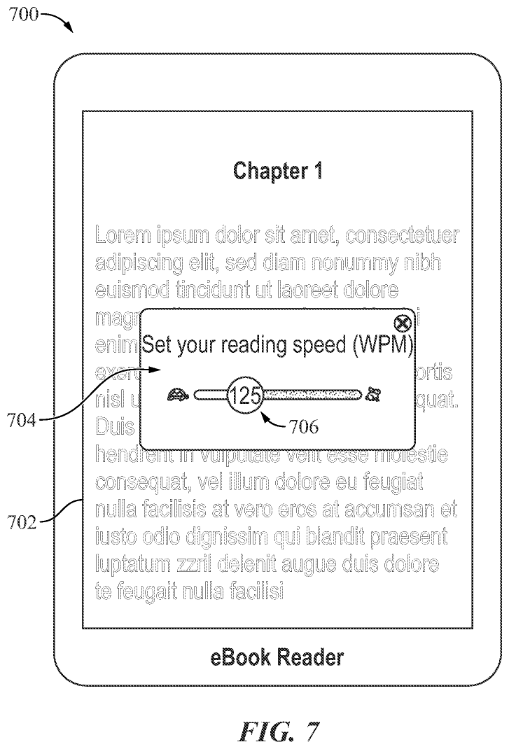

FIG. 7 illustrates an embodiment with a speed setting modification feature on an eReader device 700. As shown in the example embodiment, a screen 702 of the device can display a window 704 upon user selection or command (e.g. selecting a button or issuing a vocal command that is received by the device, processed, and implemented), which can allow the user to manually adjust a slider 706 or other speed modification control mechanism (e.g. entering a target speed in an input field, selecting radio buttons, or others, as appropriate). Moving the slider to the right can increase page turning speed (represented by, e.g., a rabbit icon). Moving the slider to the left can decrease page turning speed (represented by, e.g., a turtle icon).

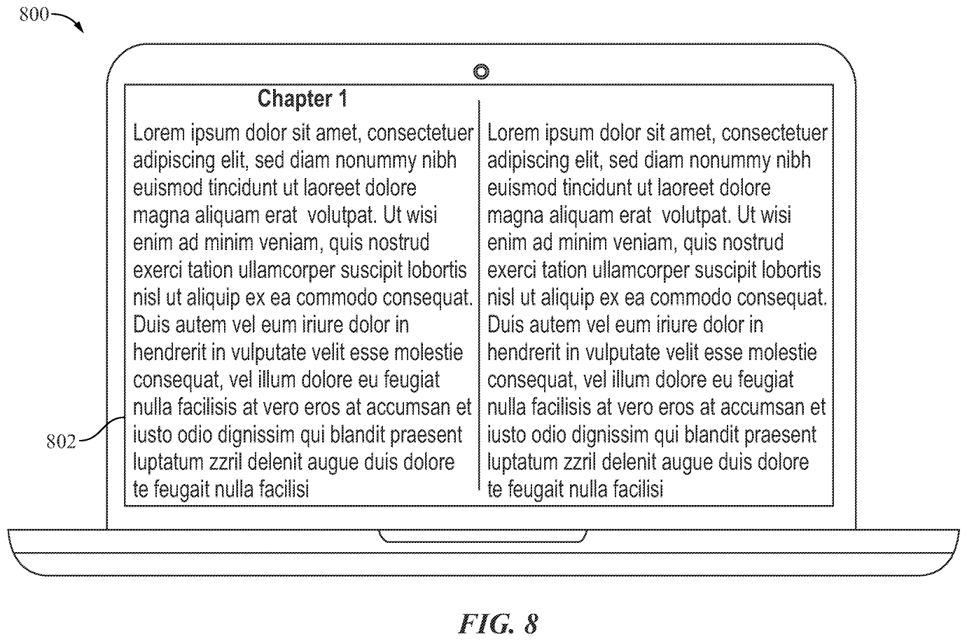

FIG. 8 illustrates an eReader on a laptop computer 800, according to some embodiments. As shown in the example embodiment, a screen 802 can display text stored within a software program stored in non-transitory computer readable memory running on the computer. The display 802 can show one or more pages with text, characters, images, or other information.

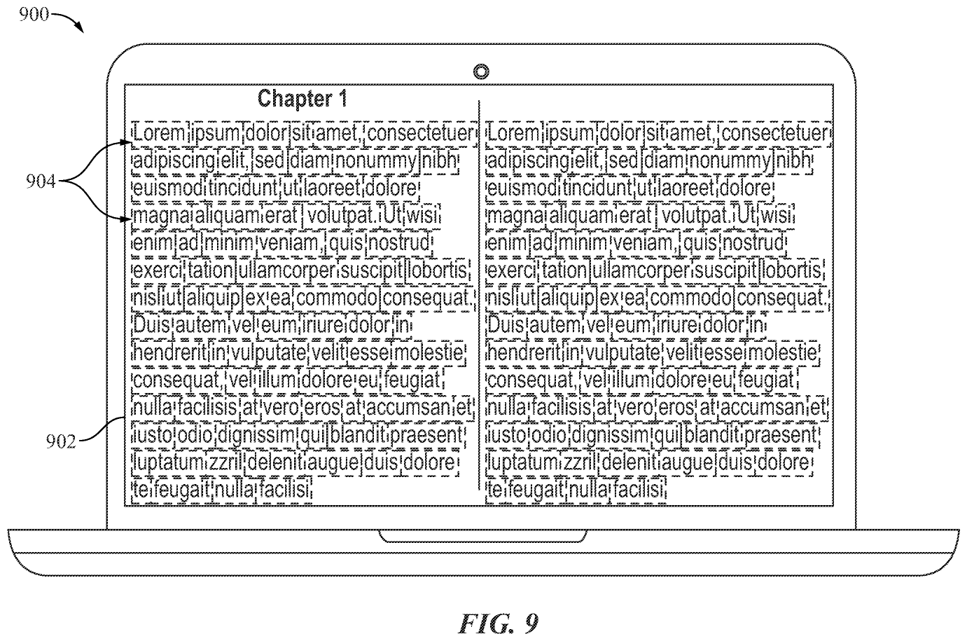

FIG. 9 illustrates a word counting operation of an eReader on a laptop computer 900, according to some embodiments. As shown in the example embodiment, the systems and methods described herein are able to determine individual words 904 on display 902 of the device, including where they begin and end, punctuation, and/or spaces in between them in various embodiments and use such information in calculations to determine and adjust appropriate page turning speeds.

FIG. 11 illustrates a letter counting operation of an eReader on a laptop computer 1000, according to some embodiments. As shown in the example embodiment, the systems and methods described herein can differentiate distinct letters, numbers, punctuation, and other characters 1004, and determine a quantity of letters, numbers, punctuation, and/or other characters displayed on a screen 1002 in its operations to determine appropriate speeds for page turning.

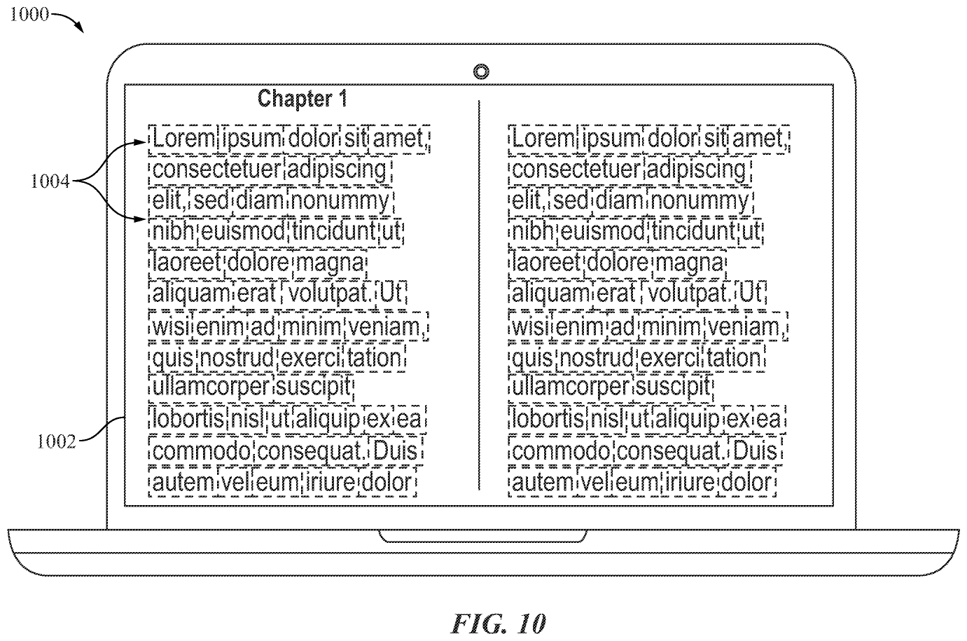

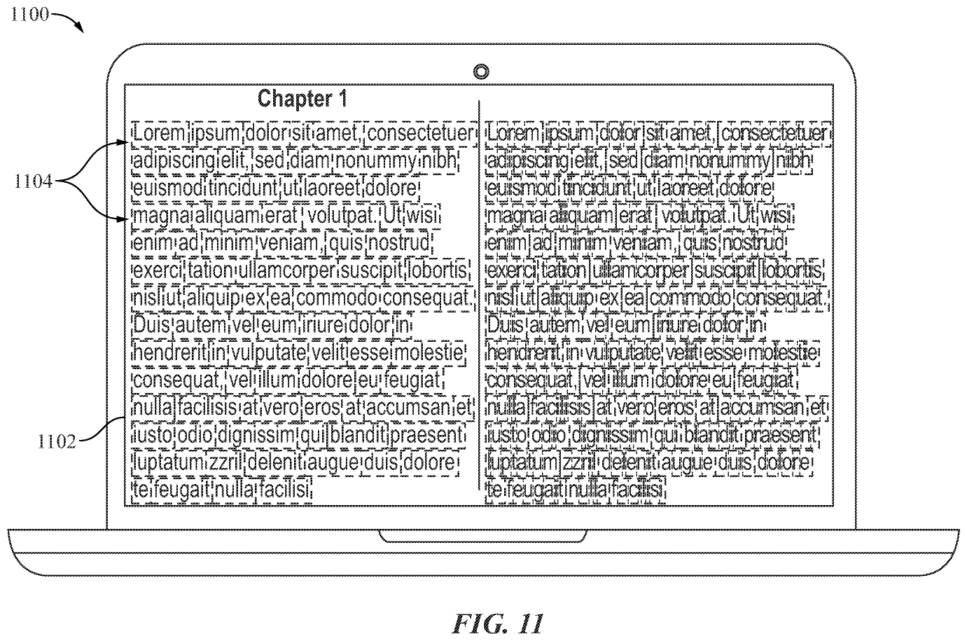

FIG. 10 illustrates a font resizing operation of an eReader on a laptop computer 1100, according to some embodiments. As shown in the example embodiment, words 1104 that are displayed on the screen 1102 of the device can be increased or decreased in size based on different zooming or display options that are user selectable or controlled by system settings, such as the device accessibility settings. The system is operable to determine adjustments in automated page turning operations based on these resizing operations by calculating the number of words (and/or characters) that are displayed on a particular screen.

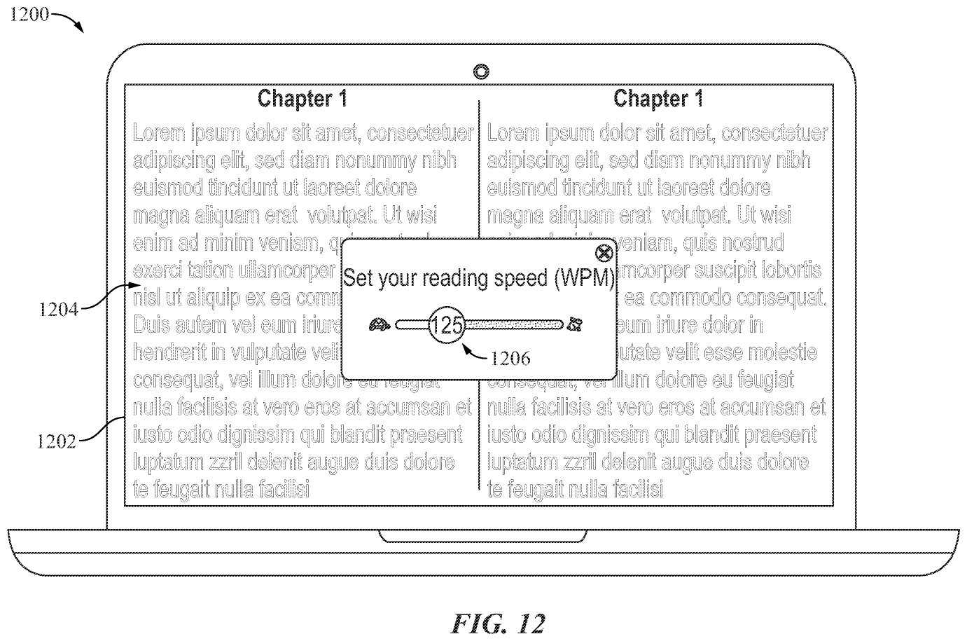

FIG. 12 illustrates speed setting modification feature of an eReader on a laptop computer 1200, according to some embodiments. As shown in the example embodiment, a screen 1202 of the device can display a window 1204 upon user selection or command (e.g. selecting a button or issuing a vocal command that is received by the device, processed, and implemented), which can allow the user to manually adjust a slider 1206 or other speed modification control mechanism (e.g. entering a speed in a field, selecting radio buttons, or others, as appropriate).

Unless otherwise defined, all technical and scientific terms used herein have the same meaning as commonly understood by one of ordinary skill in the art to which this invention belongs. All publications, patent applications, patents, and other references mentioned herein are incorporated-by-reference in their entirety to the extent allowed by applicable law and regulations. The systems and methods described herein can be embodied in other specific forms without departing from the spirit or essential attributes thereof, and it is therefore desired that the present embodiment be considered in all respects as illustrative and not restrictive. Any headings utilized within the description are for convenience only and are not intended to have legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, should be considered, along with the knowledge, understanding, and information available to one of ordinary skill in the art to constitute a complete written description of all combinations and subcombinations of the embodiments described herein, and of the manner and process of making and using them, and should be read and interpreted to support claims to any such combination or subcombination.

The foregoing is provided for purposes of illustrating, explaining, and describing embodiments of this disclosure. Modifications and adaptations to these embodiments will be apparent to those skilled in the art and can be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments can be recited in or added to the claims, as well as negative limitations that define the inventive scope of the claims by features, functions, steps, or elements that are not within that scope fall within the spirit of the disclosure.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An automated speed control system for page turning of an eReader, comprising:
instructions stored in non-transitory computer readable memory that, when executed by the processor of the eReader, cause the processor to:
determine a baseline speed at which a user reads a page;
calculate a number of words displayed on a page;
based on the number of words displayed, start a timer; and
upon expiration of the timer, automatically turn the page.

2. The automated speed control system for page turning of an eReader of claim 1, wherein the instructions further cause the processor to:
calculate a number of characters on a page and, based on the number of characters, start or modify the timer.

3. The automated speed control system for page turning of an eReader of claim 1, wherein the instructions further cause the processor to:
monitor a user's reading speed and, based on that speed, adjust the timer to reduce the baseline speed.

4. The automated speed control system for page turning of an eReader of claim 1, wherein the instructions further cause the processor to:
monitor a user's reading speed and, based on that speed, adjust the timer to increase the baseline speed.

5. The automated speed control system for page turning of an eReader of claim 1, wherein the instructions further cause the processor to:
turn the page prior to expiration of the timer if a user selects a next page button.

6. The automated speed control system for page turning of an eReader of claim 5, wherein the instructions further cause the processor to:
adjust the timer to increase the baseline speed after the user selects the next page button.

7. The automated speed control system for page turning of an eReader of claim 1, wherein the instructions further cause the processor to:
set the baseline speed based on a user manually setting the baseline speed.

8. The automated speed control system for page turning of an eReader of claim 1, wherein the instructions further cause the processor to:
visually display the timer on a display of the eReader.

9. The automated speed control system for page turning of an eReader of claim 1, wherein the instructions further cause the processor to:
recalculate the number of words displayed on a page based on the user modifying a display setting by zooming-in or zooming-out to adjust the size of the text.

10. The automated speed control system for page turning of an eReader of claim 9, wherein the display setting is an eReader display window size on a display of the eReader.

11. A method of automatically controlling page turn speed on an eReader, comprising a series of steps that are stored in non-transitory computer readable memory that, when executed by the processor of the eReader, cause the processor to:
determine a baseline speed at which a user reads a page;
calculate a number of words on a page to be displayed;
based on the number of words to be displayed, start a timer; and
upon expiration of the timer, automatically turn the page.

12. The method of automatically controlling page turn speed on an eReader of claim 11, comprising further steps that cause the processor to:
calculate a number of characters on a page to be displayed and, based on the number of characters to be displayed, start or modify the timer.

13. The method of automatically controlling page turn speed on an eReader of claim 11, comprising further steps that cause the processor to:
monitor a user's reading speed and, based on that speed, adjust the timer to reduce the baseline speed.

14. The method of automatically controlling page turn speed on an eReader of claim 11, comprising further steps that cause the processor to:
monitor a user's reading speed and, based on that speed, adjust the timer to increase the baseline speed.

15. The method of automatically controlling page turn speed on an eReader of claim 11, comprising further steps that cause the processor to:
turn the page prior to expiration of the timer if a user selects a next page button.

16. The method of automatically controlling page turn speed on an eReader of claim 15, comprising further steps that cause the processor to:
adjust the timer to increase the baseline speed after the user selects the next page button.

17. The method of automatically controlling page turn speed on an eReader of claim 15, comprising further steps that cause the processor to:
adjust the timer to decrease the baseline speed after the user selects a previous page button.

18. The method of automatically controlling page turn speed on an eReader of claim 11, comprising further steps that cause the processor to:
set the baseline speed based on a user manually setting their baseline speed.

19. The method of automatically controlling page turn speed on an eReader of claim 11, comprising further steps that cause the processor to:
visually display the timer on a display of the eReader.

20. The method of automatically controlling page turn speed on an eReader of claim 11, comprising further steps that cause the processor to:
recalculate a number of words on a page to be displayed based on the user modifying a display setting.

21. An eReader apparatus that is operable to automatically adjust page turning speed, comprising:
a processor;
a display; and
instructions stored in non-transitory computer readable memory that, when executed by the processor of the eReader, cause the processor to:
determine a baseline speed at which a user reads a page;
calculate a number of words on a page to be displayed on the display;
based on the calculated number of words to be displayed, start a timer; and
upon expiration of the timer, automatically turn the page.
